(19) United States
(12) Patent Application Publication
(10) Pub. No.: US 2011/0065477 A1
(43) Pub. Date: Mar. 17, 2011

(54) MULTIBAND BUILT-IN ANTENNA FOR PORTABLE TERMINAL

(75) Inventors: Kyung-Bae KO, Gyeonggi-do (KR); Jung-Ho PARK, Gyeonggi-do (KR); Austin KIM, Gyeonggi-do (KR); Dong-Hwan KIM, Gyeonggi-do (KR); Yong-Jin KIM, Seoul (KR); Ja-Ho LEE, Gyeonggi-do (KR); Se-Ho KIM, Gangwon-do (KR)

(73) Assignee: SAMSUNG ELECTRONICS CO., LTD., Gyeonggi-Do (KR)

(21) Appl. No.: 12/881,250

(22) Filed: Sep. 14, 2010

(30) Foreign Application Priority Data
Sep. 16, 2009 (KR) 10-2009-0087416

(51) Int. Cl. H04M 1/00; H01Q 1/50; H01Q 3/24; H01Q 9/04

(52) U.S. Cl. 455/562.1; 343/860; 343/876; 343/700 MS

(57) ABSTRACT

A multiband built-in antenna for a portable terminal is provided, which includes a feeding part electrically connected to a Radio Frequency (RF) connector of a terminal main board; an antenna radiator comprising at least two ground parts electrically connected to a ground means of the terminal and formed at different locations; and a switching means commonly linked to a ground line of each ground part of the antenna radiator, and selectively connecting one or more of the at least two ground parts electrically to the ground means according to a switching operation

### CLAIM OF PRIORITY

This application claims priority to and the benefit of the earlier filing date, under 35 U.S.C. §119(a), to that patent application filed in the Korean Intellectual Property Office on Sep. 16, 2009 and assigned Serial No. 10-2009-0087416, the entire disclosure of which is incorporated by reference in its entirety, herein.

### FIELD OF THE INVENTION

The present invention relates to the field of multiband antenna for a portable terminal. More particularly, the present invention relates to a multiband built-in antenna of a portable terminal to realize good radiation characteristics in a corresponding band.

### BACKGROUND OF THE INVENTION

Portable terminals with various functions and diverse designs are emerging and becoming slimmer, thinner, and simpler. At the same time, the functional diversity of the terminals is noticeable. To satisfy a user's need in this regard, it is necessary to reduce a volume of the terminal while maintaining or enhancing its functions. Portable terminals as used herein may represent cellular telephones or personal digital assistants (PDA) and/or tablet devices with wireless communication capability or other similar type of devices.

Generally, portable terminals have used conventional external antennas that protrude outside the terminal body. For example, a rod antenna (or a whip antenna) or a helical antenna as the antenna, which are typically installed to project outside of the terminal body for a certain length. This projection outside of the terminal body makes the antenna a vulnerable part of the terminal, as it is subject to damage when the terminal is dropped, for example. This vulnerability can impair the portability of the terminal. Thus, plate type, built-in, antennas (called internal antennas or intennas) that are embedded in the terminal are mostly used so as to enhance the characteristics of the terminal and to improve assembly and productivity.

Typically, the plate type antenna is mounted on a carrier of a certain height and provides a distance between a lower main board and a ground plane, thus realizing a good radiation performance. Moreover, the plate type antenna is formed to implement multiple bands (for example, at least two resonance points) with one radiator because the upper slot form of the radiator can vary in accordance with the intended bands. For example, the antenna may be implemented to use one terminal over various different bands. That is, the single antenna radiator can realize the radiation characteristics in various bands such as GSM850 band (824 MHz to 894 MHz), GSM900 band (880 MHz to 960 MHz), DCS1800 band (1710 MHz to 1880 MHz), and PCS1900 band (1850 MHz to 1990 MHz).

However, as a multiband antenna, which needs to realize various resonance lengths, it is hard to support all of the necessary multiple bands in the smaller antenna radiator installation space. As a result, in some of the bands, the radiation performance is substantially degraded because the gain of the antenna radiator is not adequately realized.

### SUMMARY OF THE INVENTION

An exemplary aspect of the present invention is to provide a multiband built-in antenna of a portable terminal for revealing better radiation characteristics even in the same antenna radiator installation space.

Another exemplary aspect of the present invention is to provide a multiband built-in antenna of a portable terminal for preventing degradation of a radiation performance even when a usage band of the terminal is changed.

Another exemplary aspect of the present invention is to provide a multiband built-in antenna of a portable terminal for realizing good radiation performance per band merely by adding a simplified construction and thus contributing to terminal performance enhancement.

In accordance with an aspect of the present invention, a multiband built-in antenna for a portable terminal includes a feeding part electrically connected to a Radio Frequency (RF) connector of a terminal main board; an antenna radiator comprising at least two ground parts electrically connected to a ground means of the terminal and formed at different locations; and a switching means commonly linked to a ground line of each ground part of the antenna radiator, and selectively connecting one or more of the at least two ground parts electrically to the ground means according to a switching operation.

In accordance with another exemplary aspect of the present invention, a portable terminal includes the antenna radiator. The portable terminal includes a main board; an antenna radiator comprising a feeding part electrically connected to an RF connector of the main board, and at least two ground parts electrically connected to a ground means of the terminal and formed at different locations; a switching means commonly linked to a ground line of each ground part of the antenna radiator, and selectively connecting one or more of the at least two ground parts to the ground means electrically according to a switching operation; and a controller for controlling the switching means such that the antenna radiator obtains desired radiation characteristics in a usage band of the terminal.

In another aspect of the invention, a multiband antenna configuration is disclosed. The configuration comprises an antenna radiator comprising at least two ground parts and a switch means connected to a ground plane at a first end and selectively connected to at least one ground part of the antenna radiator at a second end, wherein the switch means determines a ground length of each the two ground parts.

### BRIEF DESCRIPTION OF THE DRAWINGS

The above and other objects, feature and advantages of the present invention will become more apparent from the following detailed description when taken in conjunction with the accompanying drawings in which:

FIG. 1 is a perspective diagram of a portable terminal 100 adopting a built-in antenna;

FIG. 2 is a simplified diagram of the built-in antenna according to an exemplary embodiment of the present invention;

FIG. 3 is a conceptual diagram of a ground system according to an exemplary embodiment of the present invention;

FIGS. 4A and 4B illustrate exemplary embodiments of a ground system according to another embodiment of the present invention; and

FIG. 5 is a diagram for comparing a standing wave ratio in multiple bands according to an exemplary embodiment of the present invention.

Throughout the drawings, like reference numerals will be understood to refer to like parts, components and structures.

### DETAILED DESCRIPTION OF THE INVENTION

The following description, with reference to the accompanying drawings, is provided to assist in an understanding of the invention claimed. Exemplary embodiments of the invention are provided herein for illustrative purposes and are not to be considered the only means for practicing the invention aimed. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion may obscure appreciation of the subject matter of the claimed invention by a person or ordinary skill in the art.

The terms and words used in the following description and claims are not limited to the bibliographical meanings, but, are merely used by the inventor to provide a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

While a bar type terminal is illustrated to explain the invention claimed, a multiband build-in antenna of the present invention is applicable to other well-known open type terminals, such as slide type terminals and folder type terminals.

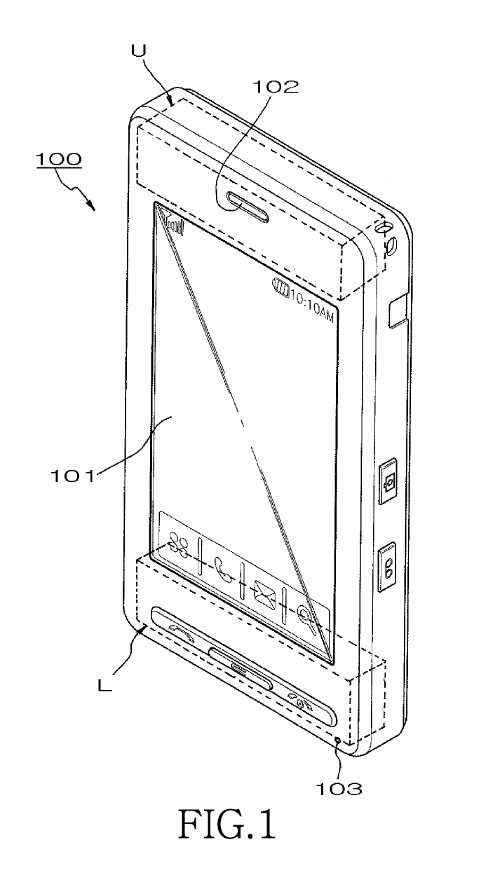

FIG. 1 is a perspective diagram of a portable terminal 100 adopting the built-in antenna. In a front side of the terminal 100, a wide Liquid Crystal Display (LCD) module 101 is installed. For example, it is advantageous to install the LCD module 101 as a touch screen. An earpiece 102, which is a telephone receiver, is installed in an upper part of the LCD module 101. A microphone device 103, which is a transmitter, is installed in a lower part of the LCD module 101. A camera module and a speaker module, that are not shown, can be further provided, and various additional devices for other well-known additional functions can be mounted.

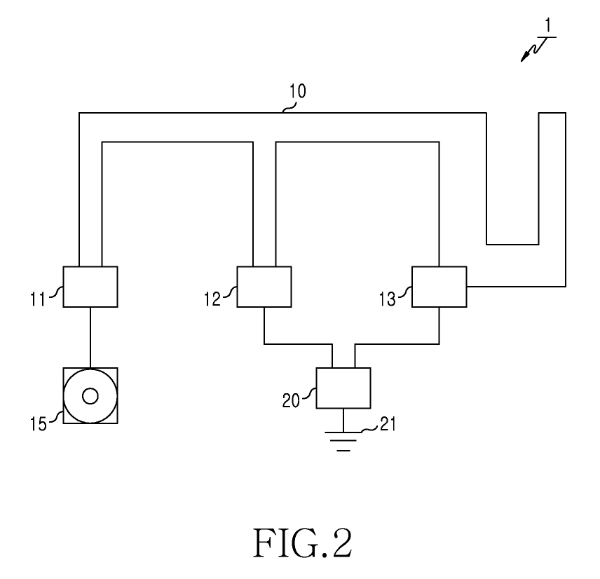

The built-in antenna 1 of FIG. 2 can be disposed at various locations of the portable terminal 100. In more detail, while the conventional antenna is installed mostly in the upper part “U” of the terminal, a change of the antenna installation space is inevitable because of the limitation of the installation space (for example, the installation of a camera module). In response to this, the antenna tends to be installed in the lower part “L” of the terminal.

The built-in antenna of the present invention operates in multiple bands, for example, in GSM850 band and GSM900 band. A terminal controller can alter a ground length of an antenna radiator according to the band change of a switching means, to implement good radiation characteristics. The switching means will be described in further detail with regard to FIG. 2.

FIG. 2 is a simplified diagram of the built-in antenna according to an exemplary embodiment of the present invention, which is embedded in the “U” part or the “L” part of the portable terminal 100 of FIG. 1.

As shown in FIG. 2, the built-in antenna 1 includes an antenna radiator 10 of a certain pattern. The antenna radiator 10 includes one feeding pad 11 and two ground pads 12 and 13. The feeding pad 11 is electrically connected with a Radio Frequency (RF) connector of a terminal main board (not shown), and the two ground pads 12 and 13 are selectively connected to a ground part 21 of the main board. Note that the connections are not limited to those, and that the ground pad can be earthed to various ground means of the terminal. Accordingly, a switching device 20 is interposed between the two ground pads 12 and 13 and the ground part 21. The switching device 20 can employ various well-known switching devices such as Single Pole Double Throw (SPDT), SPST, SP3T, and SP4T. In the illustrated embodiments a SPDT switch is shown. However, it would be recognized that an SP3T switch may be used when three modes of operation are available to the terminal. Similarly, a SP4T switch may be used when four modes of operation are available to the terminal. The specific type of switch may further depend upon the electrical characteristics of the switch and its effect on any resonance within the ground part. Such determination of the specific switch may be performed without undue experimentation on the part of those practicing the invention claimed. Hence, a specific implementation of the switch or switch type need not be provided herein. In addition, it would be recognized that the switch means may be one of a physical switch or switches or may be one of an electronic switch or switches. Thus, the user may physically set a mode of the portable terminal by setting the physical switch in one position or another. With the use of an electronic switch, the portable terminal may dynamically control the position of the switch to accommodate different bands. The setting of the electronic switch(s) may be set by a controller (not shown) that is an element of the portable terminal. The controller and other elements, such as the transmitting and receiving system, the keypad, display, etc., are well-known elements of a portable terminal and have not been discussed herein in order not to obscure the subject matter of the invention claimed.

In this exemplary embodiment, the two ground pads 12 and 13 are set and switched, but the number of the ground pads is not limited to two. For example, two or more ground pads can be constructed and switched in various manners.

Generally, in the antenna radiator, the location of a short circuit of the ground pad determines the surface current, and the length of the current determines a resonance band of the antenna radiator. Using these properties, the present invention determines the optimum surface current length in the corresponding band by varying the length of the surface current. Preferably, the antenna radiator can be a Planar Inverted F Antenna (PIFA).

For example, the surface current length of the two ground pads 12 and 13 of FIG. 2 is different from each other. One ground pad 12 is formed to have the relatively longer surface current than the other ground pad 13. A common pole of the switching device can face the ground part of the antenna radiator, and an output pole can face the ground means.

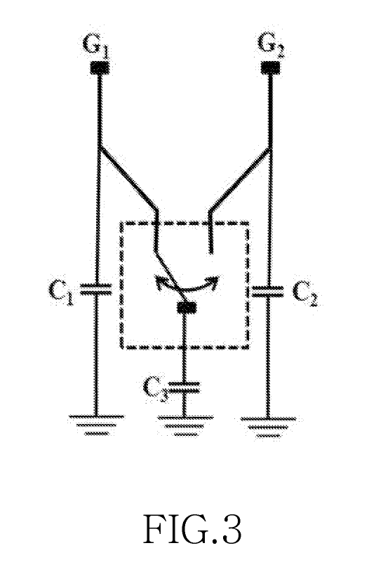

FIG. 3 is a conceptual diagram of a ground system according to an exemplary embodiment of the present invention. A short circuit is connected in both sides of a central switching device. One short circuit G1 corresponds to the ground pad 12 of FIG. 2, and the other short circuit G2 corresponds to the other ground pad 13. As a matching circuit, capacitors C1, C2, and C3 are coupled between each short circuit G1, G2 and the ground part 21. While the matching circuit employs the illustrated capacitors, it would be recognized that the matching circuits may also be replaced by or may include a resistance R, a reactance (inductance) L, or a NC (No Connection) in combination. Resistance R, reactance L, capacitance C and NC can function as an ESD protection circuit for protecting the switching device, a DC block, an LPF (low pass filter) and a HPF (high pass filter).

Hence, when the ground part of the main board is shorted out from the short circuit G1 and the short circuit G2 is concurrently open due to the switching device, the length of the surface current is adjusted to have substantially optimal band characteristics in the GSM850 band, for example. Conversely, when the ground part of the main board is shorted out from the short circuit G2 and the short circuit G1 is concurrently open due to the switching device, the length of the surface current is adjusted to have a substantially optimal band characteristic in the GSM900 band, for example. It would be recognized that the antenna characteristics may be obtained for other frequency bands using the same principles by adjusting the lengths accordingly.

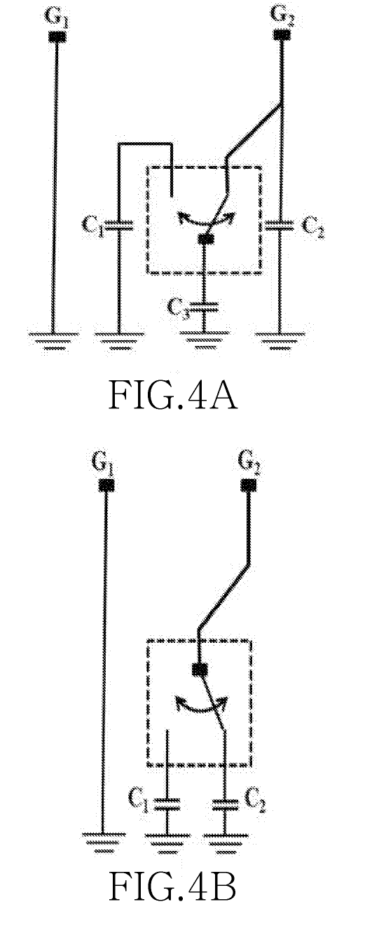

FIGS. 4A and 4B illustrate conceptual diagrams of the ground system according to another exemplary embodiment of the present invention, wherein the short circuit G1 is electrically connected to the ground part of the terminal main board all the time.

In FIGS. 4A and 4B, the short circuit G1 is electrically connected to the ground part of the main board all the time, and the switching means selectively shorts out short circuit G2. At this time, when the switching means opens the G2, the ground part is electrically connected with the capacitance C1 coupled at a separate location.

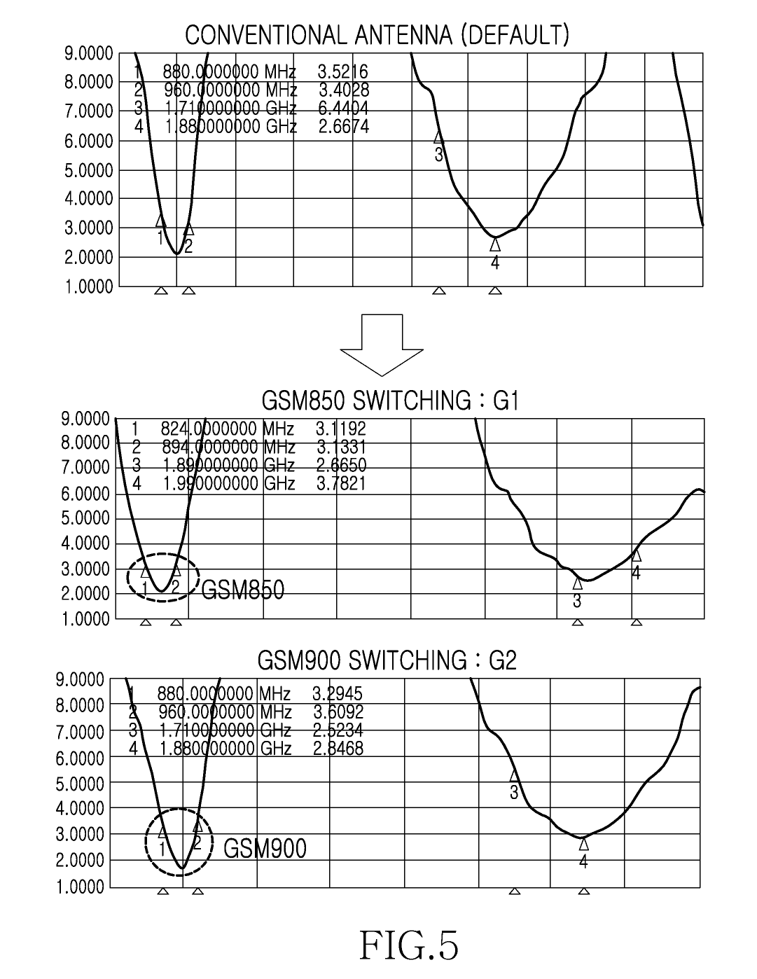

FIG. 5 is a diagram for comparing a standing wave ratio in the multiple bands according to an exemplary embodiment of the present invention, which is explained by referring to Table 1

TABLE 1

| | 3D Efficiency | | | | | |
|---|---|---|---|---|---|---|
| | GSM850 | | GSM900 | | GSM1800 | |
| | Tx | Rx | Tx | Rx | Tx | Rx |
| Default | 18 | 24 | 28 | 30 | 8 | 23 |
| GSM850 S/W | 30 | 34 | | | | |
| GSM900 S/W | | | 33 | 34 | 23 | 29 |
| Δ | 12 ↑ | 10 ↑ | 5 ↑ | 4 ↑ | 15 ↑ | 6 ↑ |

As shown in Table 1, the conventional antenna obtains the efficiency of about 18% in the GSM850 transmit mode due to the bandwidth, whereas the multiband antenna of the present invention can enhance the GSM900 transmit mode by 30%. That is, when both of the GSM850 and GSM900 bands are used together with the single antenna radiator, the possible GSM850 transmit mode efficiency degradation can be addressed.

The built-in antenna according to exemplary embodiments of the present invention can contribute to the terminal performance enhancement by realizing a higher antenna radiation efficiency in the different bands merely with the simple switching operation.

In one aspect of the invention, the switch described may be set to process one band or the other based on a setting provided by the user. In another aspect of the invention, the switch may be set based on the characteristics of a received signal (e.g., received frequency). In still another aspect of the invention, the switch may be periodically toggled between the first and second (and any other additional bands) to provide a desired reception of an incoming signal, independent of the frequency (or band) of the incoming signal.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A multiband built-in antenna for a portable terminal, comprising:
a feeding part electrically connected to a Radio Frequency (RF) connector of a terminal main board;
an antenna radiator comprising at least two ground parts electrically connected to a ground means of the terminal and formed at different locations; and
a switching means commonly linked to a ground line of each ground part of the antenna radiator, and selectively connecting one or more of the at least two ground parts electrically to the ground means according to a switching operation,
wherein a common pole of the switching means faces the ground part of the antenna radiator, and an output pole faces the ground means.

2. The multiband built-in antenna of claim 1, wherein the location of each ground part is determined by considering a length of surface current of the antenna radiator.

3. The multiband built-in antenna of claim 1, wherein the antenna radiator is a Planar Inverted F Antenna (PIFA).

4. The multiband built-in antenna of claim 1, wherein a matching circuit is interposed in at least one of: a ground line between each ground part and the switching means, and between the switching means and the ground means.

5. The multiband built-in antenna of claim 4, wherein the matching circuit is a combination comprising at least one element selected from the group consisting of: a capacitance C, a resistance, R, a reactance L, and a NC (No Connection).

6. The multiband built-in antenna of claim 1, wherein two ground parts are disposed at different locations, and the switching means is a Single Pole Double Throw (SPDT).

7. A multiband portable terminal comprising:
a main board;
an antenna radiator comprising a feeding part electrically connected to a Radio Frequency (RF) connector of the main board, and at least two ground parts electrically connected to a ground means of the terminal and formed at different locations;
a switching means commonly linked to a ground line of each ground part of the antenna radiator, and selectively connecting one or more of the at least two ground parts electrically to the ground means according to a switching operation; and
a controller for controlling the switching means such that the antenna radiator obtains a substantially optimum radiation characteristic according to a usage band of the terminal.

8. The multiband portable terminal of claim 7, wherein the location of each ground part is determined by considering a length of surface current of the antenna radiator.

9. The multiband portable terminal of claim 7, wherein the antenna radiator is a Planar Inverted F Antenna (PIFA).

10. The multiband portable terminal of claim 7, wherein a matching circuit is interposed at least in one of: a ground line between each ground part and the switching means, and between the switching means and the ground means.

11. The multiband portable terminal of claim 10, wherein the matching circuit is a combination comprising at least one element selected from the group consisting of: a capacitance C, a resistance, R, a reactance L, and a NC(No Connection).

12. The multiband portable terminal of claim 7, wherein two ground parts are disposed at different locations, and the switching means is a Single Pole Double Throw (SPDT).

13. The multiband portable terminal of claim 7, wherein in the radiation characteristic is at least one selected from the group consisting of: transmission gain and, receiving gain.

14. A multiband antenna configuration comprising:
an antenna radiator comprising at least two ground parts;
a switch means connected to a ground plane at a first end and selectively connected to at least one ground part of the antenna radiator at a second end, wherein the switch means determines a ground length of each the two ground parts.

15. The multiband antenna configuration of claim 14, further comprising:
a matching circuit between the first end of the switch means and the ground plane.

16. The multiband antenna configuration of claim 15, wherein the matching circuit comprises at least one element selected from the group consisting of: a resistance (R), a capacitance (C), an inductance (L), NC(No Connection) and combinations thereof.

17. The multiband antenna configuration of claim 15, wherein the switch means is selected from the group consisting of: a physical switch and an electronic switch.
